(19) United States
(12) Patent Application Publication
(10) Pub. No.: US 2025/0289539 A1
(43) Pub. Date: Sep. 18, 2025

(54) VIRTUAL INTERACTIVE SYSTEM FOR HULL LOAD IDENTIFICATION AND FULL-FIELD SAFETY ASSESSMENT

(71) Applicant: SHANGHAI JIAO TONG UNIVERSITY, Shanghai (CN)

(72) Inventors: Guijie SHI, Shanghai (CN); Deyu WANG, Shanghai (CN); Chuntong LI, Shanghai (CN); Zhonghua CAI, Shanghai (CN); Jiaqi JIANG, Shanghai (CN); Tianqi FEI, Shanghai (CN)

(21) Appl. No.: 19/024,169

(22) Filed: Jan. 16, 2025

(30) Foreign Application Priority Data
Mar. 13, 2024 (CN) 202410284194.6

(51) Int. Cl. B63B 43/02; G06F 3/01

(52) U.S. Cl. CPC B63B 43/02; G06F 3/011

(57) ABSTRACT

Provided is a virtual interactive system for hull load identification and full-field safety assessment, which includes a structure strain and acceleration monitoring module, a hull motion monitoring module, a hull load identification module, a hull full-field structural response calculation module, a hull wave environment identification module, a ship response virtual interaction module, a ship response 3D visualization module, a real-time safety assessment module, and a system storage and output module.

### CROSS-REFERENCE TO RELATED APPLICATIONS

This application claims priority to Chinese Patent Application No. 202410284194.6, filed on Mar. 13 2024, the contents of which are hereby incorporated by reference.

### TECHNICAL FIELD

The application belongs to the technical field of ship operation safety management, in particular to a virtual interactive system for hull load identification and full-field safety assessment.

### BACKGROUND

With the wide application of intelligent technology, intelligent ship operation has become an inevitable development trend, and emerging products of intelligent ships and unmanned ships have made appearance in recent years. In view of the complex marine environment of ship operation, a key nodus of ship intelligence is how to master the real-time dynamic scenarios of the ship and the water area.

In order to adapt to the development needs of ship intelligence, the key areas of the hull are equipped with strain or acceleration sensors for measuring the structural response and motion response of the hull, mastering the actual situation of the ship in the sea wave, and providing basic data for ship intelligent operation.

On the basis of the measured data of the hull, the threshold of ship safety assessment is set according to the previous experience or the evaluation criteria of the ship design code, and the early warning information of dangerous working conditions or sea conditions is provided. This system has been installed in some ship types to obtain monitoring data and provide reference for ship safety-oriented decision-making

The existing hull monitoring system has the following problems: (1) hull monitoring can only provide data information of limited measurement points, and cannot obtain full-field response information of the hull, resulting in no measurement results in the dangerous area; (2) ship monitoring data is limited to ship response, and the surrounding sea state environmental data is not timely grasped, which makes it difficult to have effective correlation between ship wave environmental loads and ship structural response; (3) the data of ship hull measurement points are discrete and volatile, and it takes a lot of time to process the data, resulting in a waste of monitoring data; (4) ship safety assessment lacks 3D scene simulation of ship wave action process and lacks immersive realistic experience.

### SUMMARY

The application provides a virtual interactive system and method for hull load identification and full-field safety assessment, and solves the problem of lack of virtual reality platform for hull safety assessment under actual sea conditions.

To realize the above purpose, the application adopts the following technical scheme:

A virtual interactive system for hull load identification and full-field safety assessment includes:
A structure strain and acceleration monitoring module is used to measure the response time history of the hull structure;
A hull motion monitoring module is used to measure hull motion time history;
A hull load identification module is used to identify the temporal and spatial distribution characteristics of the hull load;
A hull full-field structural response calculation module is used to calculate the full-field structural response characteristics under specific loads;
A hull wave environment identification module is used to identify the wave sea state encountered by the ship;
A ship response virtual interaction module is used for human-computer interaction aided by VR handle/headset/voice with ship virtual reality scene;
A ship response virtual roaming module is used to provide close observation and virtual experience for people inside the ship space;
A ship response 3D visualization module is used to view the virtual reality response scene from a global perspective, local perspectives and multiple perspectives;
A real-time safety assessment module is used to assess whether the hull structure deformation, yield, buckling, fatigue, ultimate strength meets the requirements.

Optionally a system storage and output module is also included for storing interactive operation information, virtual reality scene information and structure safety assessment result information, and outputting the information in the form of cloud maps, curves and data tables.

Optionally, the structure strain and acceleration monitoring module is used to obtain smooth timing signals of different measurement points, and the module separates the effective components of the signal through low-pass filtering and high-pass filtering based on the measurement signals of the strain sensor and the acceleration sensor.

Optionally, the hull motion monitoring module is used to extract the hull motion period, amplitude and meaningful characteristic information according to the real-time data of hull position, attitude and acceleration by cleaning data cleaning, removing noise, sorting and transforming, and to obtain the time history of ship rolling, pitching and heaving motion.

Optionally, the hull load identification module is used to establish the transfer function matrix between the response point and the total longitudinal load based on the structural response data, and to obtain the vertical wave/still water bending moment, horizontal wave/still water bending moment, and wave/still water torsional total longitudinal load of the hull, and to form the distribution expression of the total longitudinal load along the ship length, based on the Lₚ norm regularization inversion algorithm.

Optionally, the ship response virtual interaction module is used to obtain the 3D scene of hull structure response and hull motion response according to the operator's command information; and the command information includes the motion information of the dummy, the visual field information, the VR handle information, and the VR voice information.

Optionally the ship response 3D visualization module is used to provide 3D simulation of structural response of deformation, stress, strain, acceleration and velocity according to the calculation results of ship structure response; use RGB legends, vector diagram and deformation diagram to show the spatial distribution changes of ship structure response and ship motion response; and to use animations, curves and tables to represent the advance or retreat of the ship.

Optionally the ship response virtual interaction module obtains the changes of the experience scene at any time and space according to the movement of the dummy in the virtual scene; forms a global, local, multi-angle views through the camera switch; realizes the 3D virtual display of ship response scene by VR headset; realizes the real-time dynamic adjustment of the scene with the aid of VR handle, changes the time node and spatial distribution of the ship response; and realizes the ship responds to the scene change acceleration, playback, scene switching and detail scaling with VR voice.

The application effectively integrates the real-time measured data of hull structure and hull movement, and improves the accuracy of hull full-field information identification; employs the load inversion algorithm to forecast the course and position of the load encountered by the ship, and to provide real-time load data for the intelligent ship operation; uses the sea state recognition algorithm to show the complex wave morphology and physical properties of the ship, and visually displays the 3D effect of ship wave interaction. The hull safety is based on the whole field information, which improves the intelligent judging ability of the ship's safe navigation. A virtual interactive scene of ship response is developed to provide users with an immersive experience of ship response with sea waves.

### BRIEF DESCRIPTION OF THE DRAWINGS

In order to more clearly state the technical scheme in the embodiment of the application or the prior art, the following is a brief introduction to the drawings to be used in the description of the embodiment or the prior art. Obviously, the drawings in the description below are only some embodiments of the application, for ordinary technicians in the field, without creative labor, additional drawings may also be obtained based on the drawings provided.

FIG. 1 is a schematic diagram of the hardware equipment on board in the embodiment of the application.

FIG. 2 is a virtual interactive system structure diagram for hull load identification and full-field safety assessment of the embodiment of the application.

FIG. 3 is a schematic diagram of hull load identification for the embodiment of the application.

FIG. 4 is a schematic diagram for calculating full-field structural response of the hull of the embodiment of the application.

FIG. 5 is a schematic diagram of hull wave environment recognition for the embodiment of the application.

FIG. 6 is the schematic diagram of the vessel response virtual roaming and interaction of the embodiment of the application.

FIG. 7 is a 3D visual schematic diagram of ship response of the embodiment of the application.

FIG. 8 is a schematic diagram of real-time safety assessment for the embodiment of the application.

### DETAILED DESCRIPTION OF THE EMBODIMENTS

The following is a clear and complete description of the technical scheme in the embodiments of the application in combination with the drawings. Obviously, the described embodiments are only some of the embodiments of the application, but not all embodiments. Based on the embodiments of the application, all other embodiments obtained by ordinary technicians in the field without making creative labor fall within the scope of protection of the application.

In order to make the above purposes, features and advantages of the application more obvious and easier to understand, the application is further explained in detail in combination with the drawings and specific embodiments.

### Embodiment 1

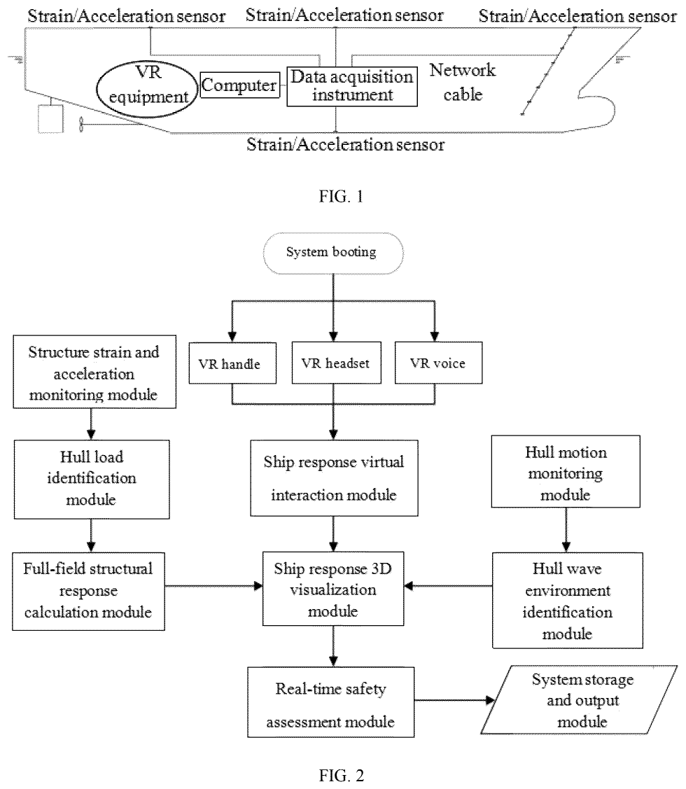

The embodiment of the application provides a virtual interactive system for hull load identification and full-field safety assessment. As shown in FIG. 1, shipboard hardware arrangement is used to obtain hull structural response; the state of strain/stress, spatial distribution of strain/stress and time history of strain/stress are determined by the strain sensor; when the acceleration sensor is installed in the position where the structure vibration is large, the acceleration sensor records the vibration response of the hull structure under dynamic loads; when the acceleration sensor is installed in the position with high stiffness, the acceleration sensor measures the motion response of the rigid hull in the sea wave. The ship monitoring information is recorded and stored by the data acquisition instrument, connected with the network through the router, and transmitted to the ship control computer system. The VR equipment equipped on board is used for experiencing the virtual scene of the embodiment of the application.

As shown in FIG. 2, the embodiment of the application provides the virtual interactive system for hull load identification and full-field safety assessment, including:
A structure strain and acceleration monitoring module used to measure the response time history of the hull structure;
A hull motion monitoring module used to measure hull motion time history;
A hull load identification module used to identify the temporal and spatial distribution characteristics of the hull load.
A hull full-field structural response calculation module used to calculate the full-field structural response characteristics under specific loads;
A hull wave environment identification module used to identify the wave state encountered by the ship;
A ship response virtual interaction module used for human-computer interaction aided by VR handle/headset/voice with ship virtual reality scene;
A ship response virtual roaming module used to provide close observation and virtual experience of personnel response inside the ship space;
A ship response 3D visualization module used to view the virtual reality response scene from global perspective, local perspective and multiple perspectives;
A real-time safety assessment module used to assess whether the hull structure deformation, yield, buckling, fatigue, ultimate strength meets the requirements;
A system storage and output module used to store interactive operation information, virtual reality scene information and structure safety assessment result information, and to output the information in the form of cloud maps, curves and data tables.

In an embodiment of the application, the structure strain and acceleration monitoring module carries out the arrangement of the structure strain and acceleration measuring points according to the requirements of the measuring points for hull load identification and the inversion of the sea state encountered by the ship; the strain sensors are arranged in the main deck, bottom of the ship, bilge plate, key cabin deck, etc., especially placed on longitudinal and transverse strong members to monitor the time history of stress changes in key areas; the acceleration sensor is used to measure the vibration response of the hull structure, and it is preferentially arranged in the area with large structural stiffness. The input data of the structure strain and acceleration monitoring module are the measurement signals of strain sensor and acceleration sensor; converted to frequency response function by Fourier transform, the effective components of the signal are separated by low-pass filtering and high-pass filtering, noise processing techniques are introduced, and then the frequency domain signals are converted to time domain signals by Fourier inverse transform; the output data of the structural strain and acceleration monitoring module are smooth timing signals of different measuring points, including statistical information such as mean value, maximum value and variance of the measured data.

In an embodiment of the application, the hull motion monitoring module uses various sensors and equipment to measure the real-time information of ship hull motion. The ship position information is measured by GPS, the hull motion attitude information is measured by gyroscope, and the hull motion acceleration information is measured by acceleration sensor. The input data of the hull motion monitoring module are the real-time data of the hull position, attitude and acceleration; by cleaning data, noise removal, sorting and transformation, the ship's motion period, amplitude and meaningful characteristic information are extracted; and the output data of the hull motion monitoring module are the motion time history of ship rolling, pitching, heaving, etc.

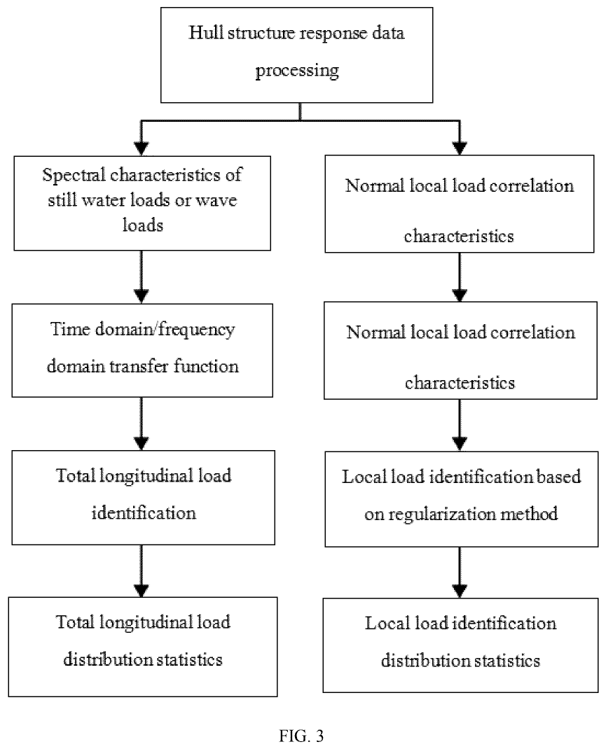

In an embodiment of the application, as shown in FIG. 3, the hull load identification module obtains the hull load from the structural response data through the inverse problem-solving method. The input data of the load identification module is the structural response measurement data of the representative position, such as strain, acceleration, etc., and the time series and spectral characteristics of the response data are extracted. By establishing the transfer function matrix between the response point and the total longitudinal load, Lₚ norm regularization inversion algorithm is introduced to solve the inadequacy of the inversion matrix, and multi-point response data is integrated to improve the accuracy of load inversion. The output data of the load identification module are the total longitudinal loads such as vertical wave/still water bending moment, horizontal wave/still water bending moment and wave/still water torsion, which are borne by the ship, forming the distribution expression of the total longitudinal load along the ship length, and getting maximum, average and meaningful values.

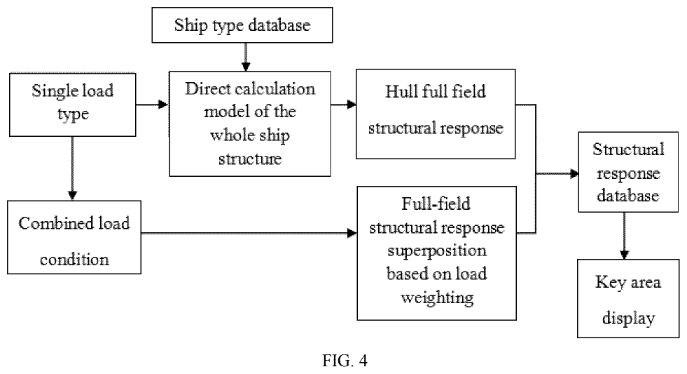

In an embodiment of the application, as shown in FIG. 4, the full-field structural response calculation module of the hull adopts the fast finite element method to calculate the hull structural response according to the identification load and hull model information, and performs data matching and optimization iteration according to the data of the structural response measurement point to acquire real-time hull full-field structural response. The input data of the full-field structural response calculation module are the output results of the load identification module and the preconfigured finite element model of the hull structure. The calculation method of full-field structural response is as follows: (1) it is classified according to different load conditions of the hull, and based on the direct calculation model of the whole ship structure, a single type of load is applied respectively to form the full-field structural response data of the hull under specific load conditions, and the structural model data and structural data are stored structurally to form the ship type database and structural response database; (2) based on the principle of linear superposition, the full field structural response data of the ship under the combined load condition are constructed by using the structural response under a single load and multiple load weighting coefficients; (3) in view of the problem that the calculation time of the structural response of the whole ship is too long, the focus area is selected first, and the structural response data in the database is extracted from the limit of this range for display, the calculation and data processing are not carried out in other non-concern areas for the time being. The output data of the full-field structural response calculation module is the calculation results of the stress, deformation, vibration and other responses of the hull structure, including the time history and spatial distribution of the structural response.

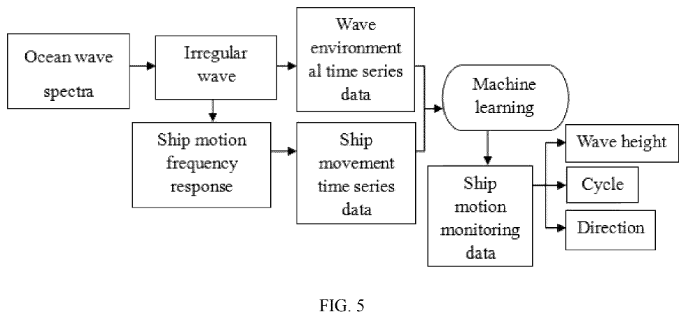

In an embodiment of the application, as shown in FIG. 5, the ship wave environment identification module establishes the mapping relationship between ship motion and wave environment according to the ship motion response data, overcomes the data measurement error and the irregularity of wave environment, and realizes the high-precision identification of ship encounter wave environment. The input data of the hull wave environment recognition module is the hull motion time series information obtained by the hull motion monitoring module, and the data is analyzed through statistical analysis, time analysis, spectrum transformation, filter transformation, etc. The calculation method of hull wave environment recognition module is as follows: (1) through numerical calculation, a series of regular waves are used to synthesize irregular waves based on wave spectrum, and the ship motion response function is established by slice theory; (2) for the time series data of ship movement and wave time calendar, the first 80% data of the time calendar is selected as the training set, and the last 20% data of the time calendar is used for testing, and the machine learning model is trained in a supervised learning environment; (3) Comprehensively analyze the influence of activation function, loss function and optimizer on wave recognition results, determine the optimal setting of wave recognition model, and establish the mapping relationship between ship rocking motion and wave. The output data of the hull wave environment identification module is the height, period, direction and other information of hull wave.

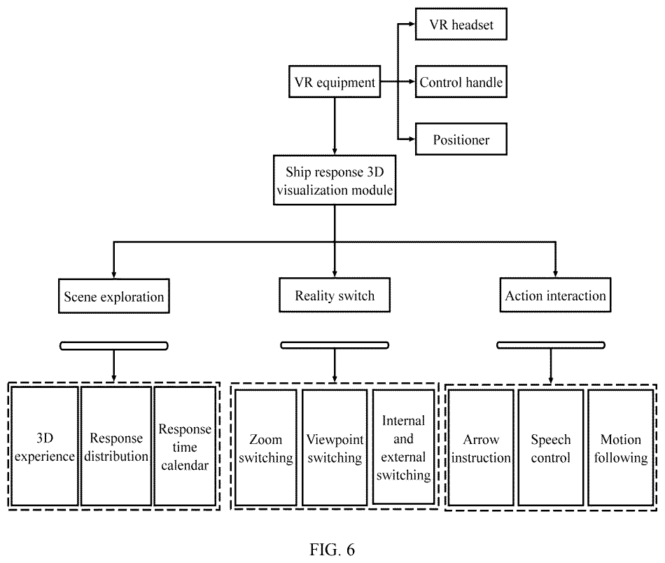

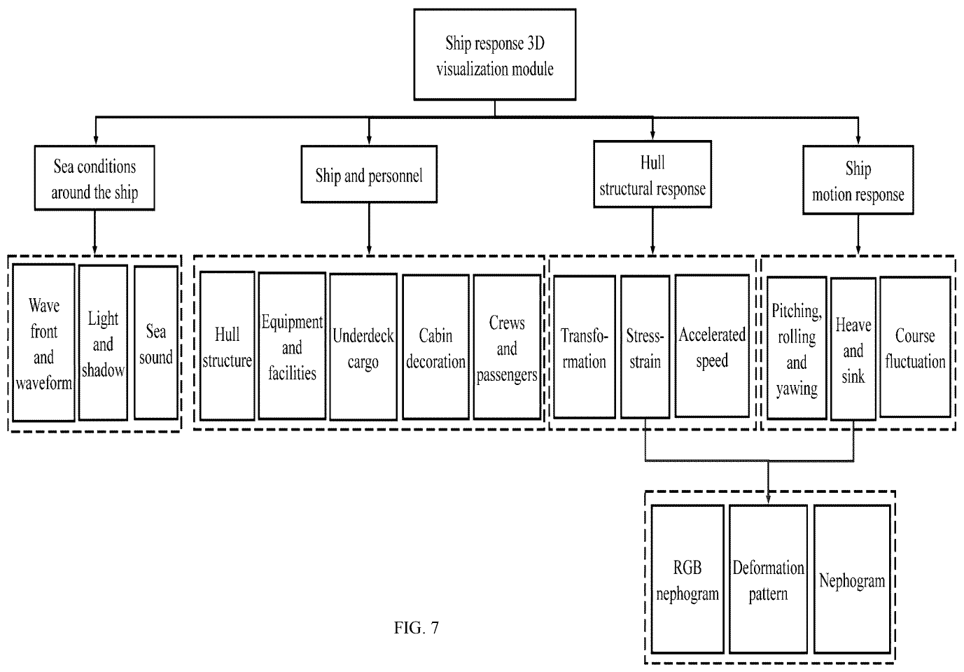

In an embodiment of the application, as shown in FIG. 6, the ship responds to the virtual roaming and interaction module, and uses the dummy to move in the virtual scene to observe and experience the changes of the scene in time and space; through the camera switch, t global, local, multi-perspective views are formed; the VR headset is used to realize 3D virtual display of ship response scene, real-time dynamic adjustment of the scene is realized by entering or clicking the information through the VR handle to change the time node and spatial distribution of the ship's response; the built-in function is mobilized through VR voice input to realize the acceleration, playback, scene switching and detail scaling of the ship's response scene, obtain the realistic display of the ship's response, and to provide a virtual software platform for ship safety assessment. The input data of the ship's response to the virtual roaming and interaction module is the operator's relevant command information, including the dummy's motion information, visual field information, VR handle information, VR voice information, etc. The calculation method of the ship response virtual roaming and interaction module is as follows: (1) structural response calculation results, hull motion data, identified wave environment and other response information are stored as structured data; (2) effective correlation between response information and preset 3D hull structure model are established through 3D physical coordinates to realize rapid call of response data at different locations; (3) through human-computer interaction instructions, the structural response data is invoked to simulate the 3D dynamic scene. The output of the ship response virtual roaming and interaction module is a 3D scene of ship structure response and ship motion response.

In an embodiment of the application, as shown in FIG. 7, the ship responds to the 3D visualization module, which is used to display the hull structure, the equipment and facilities on board, the cargo in the cabin, the personnel in the living and public places, and the interior decoration, allowing to adjust the appearance and form of color, material, light, etc.; according to the calculation results of ship structural response, three-dimensional simulation of structural response such as structural deformation, stress, strain, acceleration and velocity is provided. RGB legends, vector diagram and deformation diagram are used to show the changes in spatial distribution of ship structural response and ship motion response. Representations such as animation, curve and table are used to provide the advance or retreat changes of the ship response with time.

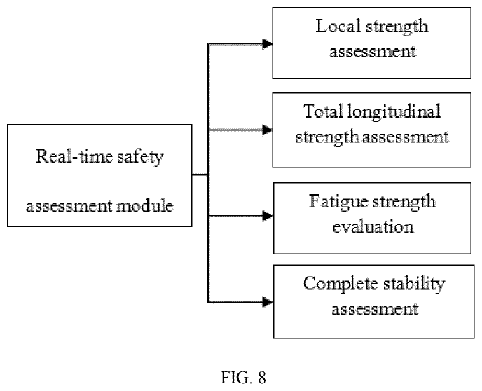

In an embodiment of the application, as shown in FIG. 8, the real-time safety evaluation module is used to carry out real-time evaluation of structural strength and ship stability according to the measurement and calculation results of ship response, and to provide ship safety evaluation results; according to the key areas of the structure and the local load identification results, the local strength evaluation of the structure is carried out; based on the effects of vertical bending, vertical shear, horizontal bending, horizontal shear, torsion, and the identification results of the total longitudinal load, the overall strength of the hull is evaluated. When the total longitudinal load exceeds a certain amplitude, the safety level of ultimate strength of the hull beam is calculated; in the area of local strength and high stress, the fatigue strength of typical nodes is evaluated by selecting typical structures and identifying the load time history information; Combined with ship motion response, the complete stability evaluation of ship is carried out.

In an embodiment of the application, the system storage and output module adopts the standard data mode to automatically save the model file information in the corresponding folder which exists in the sequence of time, so as to facilitate the subsequent direct invocation of the virtual scene; all interactive operations are saved in specific files, and information such as operation time, operation commands, and feedback results is recorded in script files; The results of identification, prediction and evaluation of the embodiment of the application are output in the form of curves and data tables.

The above embodiments are only a description of some optional embodiments of the application, and do not limit the scope of the application. Under the premise of not deviating from the design spirit of the application, all kinds of changes and improvement of the technical scheme of the application made by ordinary technicians in the art shall fall within the scope of protection determined by the claims of the application.

What is claimed is:

1. A virtual interactive system and method for hull load identification and full-field safety assessment, comprising:
a structure strain and acceleration monitoring module for measuring response time history of a hull structure;
a hull motion monitoring module for measuring hull motion time history;
a hull load identification module for identifying temporal and spatial distribution characteristics of the hull load;
a hull full-field structural response calculation module for calculating full-field structural response characteristics under specific loads;
a hull wave environment identification module for identifying wave conditions encountered by a ship;
a ship response virtual interaction module for human-computer interaction between VR handle/headset/voice and ship virtual reality scene;
a ship response virtual roaming module for providing close observation and virtual experience of personnel response inside ship space;
a ship response 3D visualization module for viewing a virtual reality response scene from a global perspective, a local perspective and multiple perspectives; and
a real-time safety assessment module for assessing whether hull structure deformation, yield, buckling, fatigue, and ultimate strength meets requirements.

2. The virtual interactive system and method for hull load identification and full-field safety assessment according to claim 1, further comprising: a system storage and output module for storing interactive operation information, virtual reality scene information and structure safety assessment result information, and outputting the information in a form of cloud maps, curves and data tables.

3. The virtual interactive system and method for hull load identification and full-field safety assessment according to claim 2, wherein the structure strain and acceleration monitoring module is used to separate effective components of signals through low-pass filtering and high-pass filtering according to measurement signals of a strain sensor and an acceleration sensor and to obtain smooth timing signals of different measurement points.

4. The virtual interactive system and method for hull load identification and full-field safety assessment according to claim 3, wherein the hull motion monitoring module is used to extract a hull motion period, amplitude and meaningful characteristic information according to real-time data of a hull position, attitude and acceleration by cleaning data, removing noise, sorting and transforming, and to obtain time history of ship rolling, pitching and heaving motion.

5. The virtual interactive system and method for hull load identification and full-field safety assessment according to claim 4, wherein the hull load identification module is used to establish a transfer function matrix between response points and a total longitudinal load according to structural response data, obtain the vertical wave/still water bending moment, horizontal wave/still water bending moment, and wave/still water torsional total longitudinal load of the hull based on Lₚ norm regularization inversion algorithm, and to form a distribution expression of a total longitudinal load along ship length.

6. The virtual interactive system and method for hull load identification and full-field safety assessment according to claim 5, wherein the ship response virtual interaction module is used to obtain a 3D scene of a hull structure response and a hull motion response according to operator's command information; and the command information comprises motion information of a dummy, visual field information, VR handle information, and VR voice information.

7. The virtual interactive system and method for hull load identification and full-field safety assessment according to claim 6, wherein the ship response 3D visualization module is used to provide 3D simulation of structural response of deformation, stress, strain, acceleration and velocity according to calculation results of ship structure response; use RGB legends, a vector diagram and a deformation diagram to show spatial distribution changes of ship structure response and ship motion response; and use animations, curves and tables to represent advance or retreat changes of the ship response with time.

8. The virtual interactive system and method for hull load identification and full-field safety assessment according to claim 7, wherein the ship response virtual interaction module obtains the changes of the experience scene at any time and space according to movements of the dummy in a virtual scene; forms a global, local, multi-perspective view through the camera switch; realizes 3D virtual display of a ship response scene by VR headset; realizes real-time dynamic adjustment of the scene through the VR handle, changes a time node and spatial distribution of the ship response;
and realizes ship response scene change acceleration, playback, view switching and detail scaling through VR voice.
